(19) United States
(12) Patent Application Publication
(10) Pub. No.: US 2025/0191397 A1
(43) Pub. Date: Jun. 12, 2025

(54) INFORMATION PROCESSING APPARATUS, AND CONTROL METHOD THEREOF

(71) Applicant: CANON KABUSHIKI KAISHA, Tokyo (JP)

(72) Inventor: TAKUYA INOUE, Ibaraki (JP)

(21) Appl. No.: 18/967,743

(22) Filed: Dec. 4, 2024

(30) Foreign Application Priority Data
Dec. 7, 2023 (JP) 2023-207173

(51) Int. Cl. G06V 30/148; G06K 15/02

(52) U.S. Cl. CPC G06V 30/153; G06K 15/1809

(57) ABSTRACT

The present invention is directed to an information processing apparatus acquiring print data and ground truth data; extracting, from the print data, for each character string region in a page where a character string is formed, information related to that character string; searching the ground truth data for information that matches at least a portion of the extracted information related to the character string; and generating a list defining the searched ground truth data and a corresponding character string region in association with each other.

### BACKGROUND OF THE INVENTION

### Field of the Invention

The present invention relates to an information processing apparatus, and a control method thereof.

### Description of the Related Art

In recent years, inspection of printed matter, which had been carried out manually, has been carried out automatically by inspection apparatuses. In an inspection apparatus, a ground truth image is registered in advance, a sheet on which print data is printed is read by a scanner or the like, and defects of the printed matter are detected by comparing the scanned image with the ground truth image registered in advance. The inspection for detecting defects of printed matter in this way is referred to as printed image inspection.

In addition to printed image inspection, in variable printing, variable region portions such as character strings are also inspected. For example, there is character string inspection in which character recognition processing is performed on a variable region portion of a scanned image and the recognition result is compared with the ground truth. In character string inspection, an inspection worker needs to manually set in advance a variable region portion inspection region and a correspondence thereof with variable data information (hereinafter, referred to as a ground truth CSV file), which is a burden on the inspection worker.

Japanese Patent Laid-Open No. 2023-31658 proposes a technique for reducing the workload of an inspection worker for when performing variable printing character string inspection.

However, the above prior art has problems to be described below. In the above prior art, the workload of designating inspection regions, which has been performed by an inspection worker, is reduced by a scanned image being analyzed and character string regions in the image being automatically extracted. Meanwhile, in the above prior art, the association of a correspondence between an inspection region, which is an inspection target, and an item in the ground truth CSV file needs to be manually performed.

### SUMMARY OF THE INVENTION

The present invention enables realization of a mechanism for automating association of ground truth data with an inspection target in character string inspection of printed matter.

One aspect of the present invention provides an information processing apparatus comprising: one or more memory devices that store a set of instructions; and one or more processors that execute the set of instructions to: acquire print data and ground truth data; extract, from the print data, for each character string region in a page where a character string is formed, information related to that character string; search the ground truth data for information that matches at least a portion of the extracted information related to the character string; and generate a list defining the searched ground truth data and a corresponding character string region in association with each other.

Another aspect of the present invention provides a method of controlling an information processing apparatus, the method comprising: acquiring print data and ground truth data; extracting, from the print data, for each character string region in a page where a character string is formed, information related to that character string; searching the ground truth data for information that matches at least a portion of the extracted information related to the character string; and generating a list defining the searched ground truth data and a corresponding character string region in association with each other.

Further features of the present invention will be apparent from the following description of exemplary embodiments with reference to the attached drawings.

### BRIEF DESCRIPTION OF THE DRAWINGS

FIG. 1 is a block diagram illustrating an example of a hardware configuration of an information processing apparatus according to one embodiment.

FIG. 2 is a diagram illustrating an example of a software configuration of the information processing apparatus according to one embodiment.

FIG. 3 is a flowchart for explaining an overall processing procedure in the information processing apparatus according to one embodiment.

FIG. 4 is a flowchart for explaining a procedure of inspection setting processing according to one embodiment.

FIGS. 5A to 5C are diagrams illustrating an example of PDL commands and drawing content of variable data according to one embodiment.

FIG. 6 is a diagram illustrating an example of a ground truth CSV file according to one embodiment.

FIGS. 7A and 7B are diagrams illustrating examples of comparison of text extracted from a PDL command with a ground truth CSV file according to one embodiment.

FIG. 8 is a diagram illustrating an example of a list of associated information in which an inspection region is associated with a row and a column of corresponding ground truth CSV according to one embodiment.

FIG. 9 is a diagram illustrating an example in which character string inspection is performed using the associated information list according to one embodiment.

FIG. 10 is a flowchart for explaining an overall processing procedure in the information processing apparatus according to one embodiment.

FIG. 11 is a flowchart for explaining a procedure of inspection setting processing in which items that do not have a match are included according to one embodiment.

FIG. 12 is a diagram illustrating an example of a ground truth CSV file including items that not have a match according to one embodiment.

FIGS. 13A and 13B are diagrams illustrating examples of comparison of text extracted from a PDL command with a ground truth CSV file according to one embodiment.

FIG. 14 is a flowchart for explaining an increase in speed of inspection setting processing according to one embodiment.

FIG. 15 is a diagram illustrating an example of comparison of text of the first page extracted from PDL with a ground truth CSV file according to one embodiment.

FIG. 16 is a diagram illustrating an example of a list of associated information of the first page according to one embodiment.

FIG. 17 is a diagram illustrating an example of comparison of text from the second page onward extracted from PDL with a ground truth CSV file according to one embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

### <Hardware Configuration>

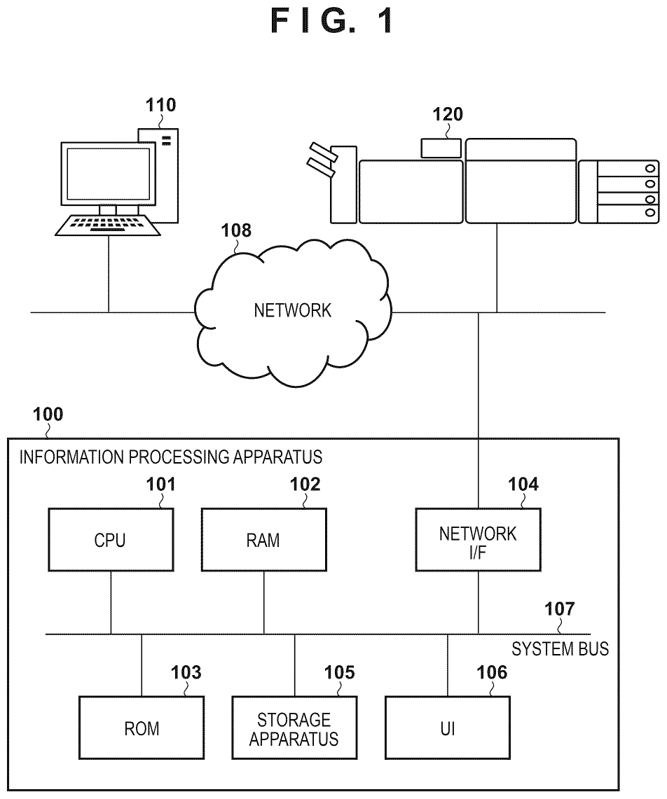

A first embodiment of the present invention will be described below. In the present embodiment, an information processing apparatus that automates designation of an inspection region and association thereof with an item in a ground truth CSV file for when performing variable printing character string inspection will be described as an example. First, an example of a hardware configuration of an information processing apparatus 100 according to the present embodiment will be described with reference to FIG. 1. The processing of the information processing apparatus 100 to be described in the present embodiment may be executed in an image forming apparatus 120 or a client terminal 110.

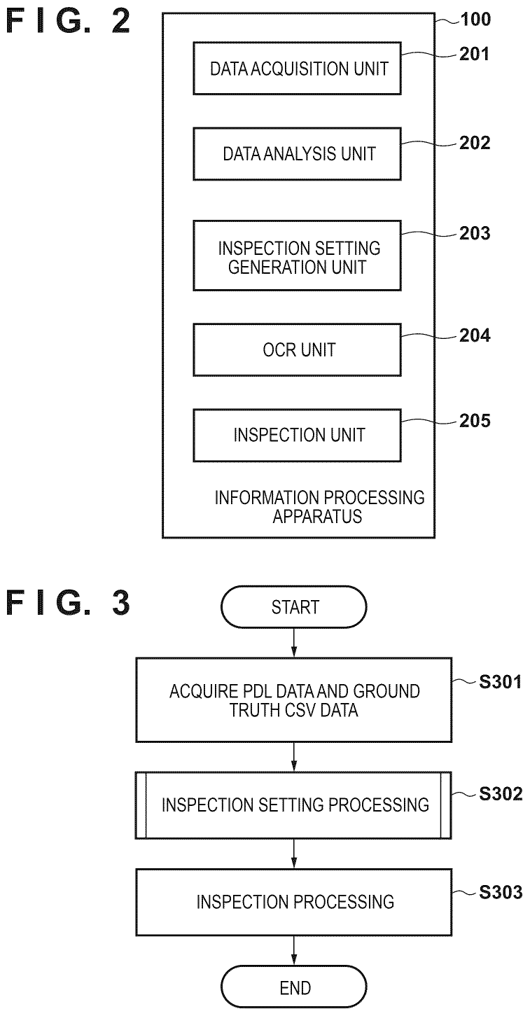

The information processing apparatus 100 includes a CPU 101, a RAM 102, a ROM 103, a network I/F 104, a storage apparatus 105, and a UI 106, each of which are connected so as to be capable of transmitting and receiving data to and from each other via a system bus 107. The CPU 101 is a central unit that controls the entire information processing apparatus 100. The RAM 102 is a storage device that can be accessed by the CPU 101, and in the present embodiment is utilized as a working memory for operation of the CPU 101. The ROM 103 stores a program, and by the CPU 101 loading and executing the program on the RAM 102, respective software modules illustrated in FIG. 2 to be described later are operated. The storage apparatus 105 is an auxiliary storage apparatus, such as an HDD or an SSD, and is used as a working region of the CPU 101 and for storing data such as a document.

The network I/F 104 is connected to the client terminal 110, the image forming apparatus 120, and the like, which are external apparatuses, through a network 108 and is an interface for inputting and outputting information. A communication network such as a local area network (LAN) or a wide area network (WAN) can be used as the network 108. However, in the present invention, the details of a communication line are not particularly limited, and the communication line may be constituted by a serial cable or the like.

The UI 106 includes a display unit and an operation unit for an operator to perform inspection settings and confirm an inspection result on the information processing apparatus 100. The present embodiment describes an example in which the information processing apparatus 100 acquires a document from the client terminal 110 through the network I/F 104. However, there is no intention of limiting the present invention, and the information processing apparatus 100 may acquire a document from the storage apparatus 105. The information processing apparatus 100 may acquire a scanned image of printed matter from the image forming apparatus 120 through the network I/F 104 or may acquire a scanned image of printed matter from the storage apparatus 105. In the above embodiment, the information processing apparatus 100 which performs inspection is a separate configuration from the image forming apparatus 120, but may be provided in the image forming apparatus 120, or may be provided in the client terminal 110 or, alternatively, a server or the like. That is, the information processing apparatus that performs inspection need only be capable of acquiring a document or a scanned image of printed matter and performing inspection, and the installation location or the device is not particularly limited.

The image forming apparatus 120 includes a scanner that reads printed matter and a printer that performs printing according to print data. In the present embodiment, the image forming apparatus 120 is described as a multifunction printer (MFP) including a scanner function and a printer function, but there is no intention of limiting the present invention. For example, an image reading apparatus including a scanner function and an image forming apparatus including a printer function may be included as system components.

### <Software Configuration>

Next, an example of a software configuration of the information processing apparatus 100 according to the present embodiment will be described with reference to FIG. 2. The information processing apparatus 100 includes software modules 201 to 205 illustrated in FIG. 2. As described above, these software modules are operated by the CPU 101 executing a program loaded from the ROM 103 to the RAM 102.

The information processing apparatus 100 includes a data acquisition unit 201, a data analysis unit 202, an inspection setting generation unit 203, an OCR unit 204, and an inspection unit 205 as software components. The data acquisition unit 201 receives files such as variable data (hereinafter, referred to as PDL data), a ground truth CSV file describing variable data information of variable data, and a scanned image of printed matter. The data analysis unit 202 acquires a page number and text data from PDL commands in the PDL data by analyzing the received PDL data. The inspection setting generation unit 203 searches the ground truth CSV file based on the acquired page number and text, and generates a list of associated information in which inspection region designation is associated with an item in the ground truth CSV file. The OCR unit 204 executes optical character recognition (hereinafter, abbreviated as OCR) processing in which character recognition is performed on the scanned image of printed matter and generates OCR text data. The inspection unit 205 performs inspection by comparing a result of performing OCR on the scanned image of printed matter with a corresponding item in the ground truth CSV file based on the associated information list.

### <Overall Processing>

Next, the entire flow from inspection setting to inspection performed by the CPU 101 according to the present embodiment will be described with reference to FIG. 3. The processing to be described below is realized, for example, by the CPU 101 reading a program stored in the ROM 103 or the storage apparatus 105 to the RAM 102 and executing the program. In the following, a step number of each process in the flowchart will be indicated by a number following “S”.

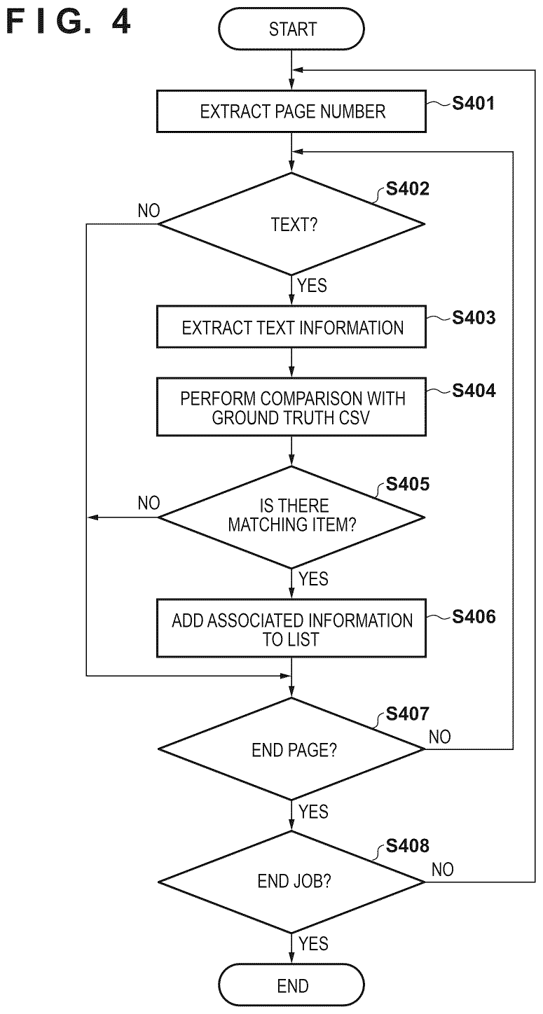

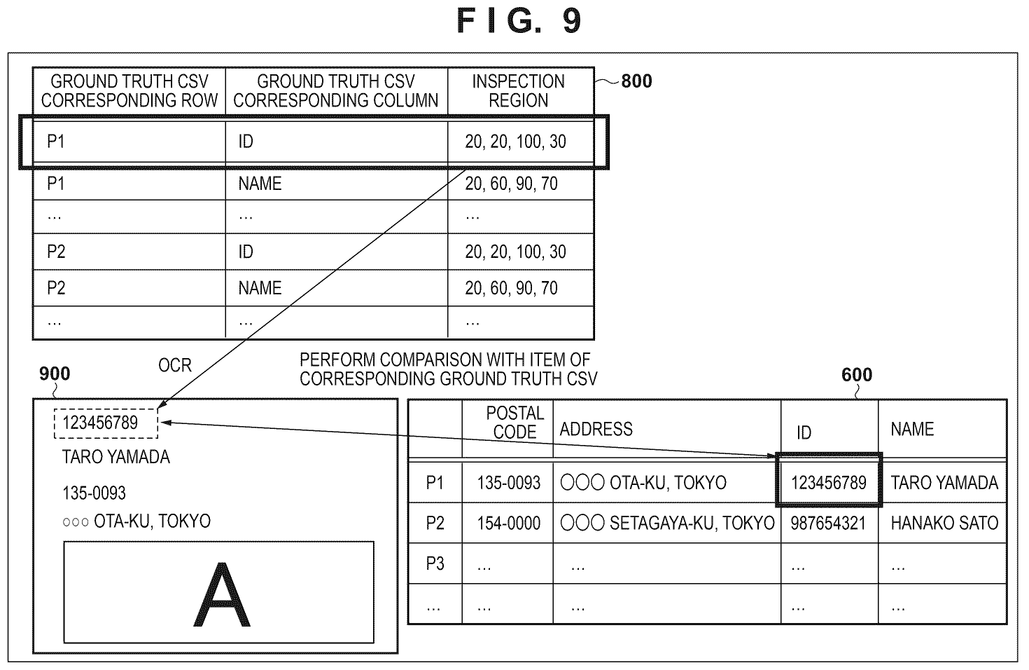

In step S301, the CPU 101 causes the data acquisition unit 201 to receive PDL data and a ground truth CSV file through the network I/F 104. Then, in step S302, the CPU 101 causes the data analysis unit 202 and the inspection setting generation unit 203 to analyze the received PDL data and compare it with the ground truth CSV file to generate a list of associated information in which an inspection region is associated with an item in the ground truth CSV file. The processing of step S302 will be described in detail later with reference to FIGS. 4 to 8. In step S303, the CPU 101 causes the OCR unit 204 and the inspection unit 205 to execute inspection processing in which OCR is performed on a scanned image of printed matter and the OCR result is compared with a corresponding item in the ground truth CSV file based on the associated information list. The processing of step S303 will be described in detail later with reference to FIG. 9.

### <PDL Data>

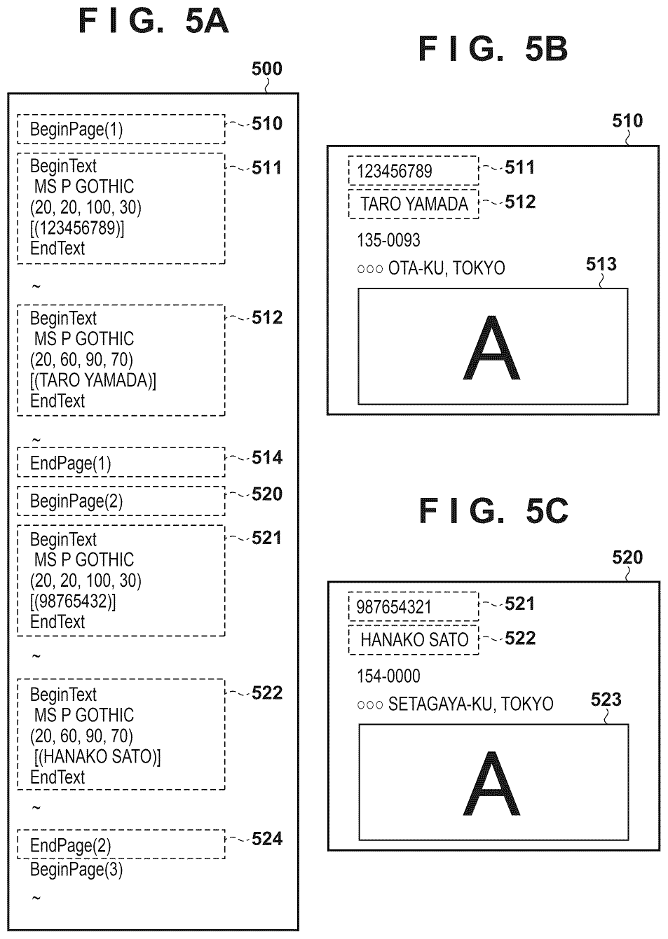

Next, PDL data will be described with reference to FIGS. 5A to 5C. FIGS. 5A to 5C illustrate an example of PDL commands and drawing content of variable data. Variable data refers to data containing a variable region portion and a fixed region portion in a page. In the example of FIGS. 5A to 5C, FIG. 5A illustrates a portion of PDL commands of the variable data, and FIGS. 5B and 5C illustrate corresponding drawing content.

Reference numeral 500 of FIG. 5A indicates all the PDL commands constituting variable data. Reference numeral 510 indicates the start of the page for the first page. Reference numeral 511 indicates information related to text. Specifically, it indicates that the font is a gothic typeface, the upper left x-coordinate of the region for drawing the character string is 20, the upper left y-coordinate is 20, the lower right x-coordinate is 100, the lower right y-coordinate is 30, and the character string to be drawn is “123456789”. Reference numeral 512 indicates information related to text. Specifically, it indicates that the font is a gothic typeface, the upper left x-coordinate of the region for drawing the character string is 20, the upper left y-coordinate is 60, the lower right x-coordinate is 90, the lower right y-coordinate is 70, and the character string to be drawn is “Taro Yamada”. Reference numeral 514 indicates the end of the page for the first page.

Reference numeral 520 indicates the start of the page for the second page. Reference numeral 521 indicates information related to text. Specifically, it indicates that the font is a gothic typeface, the upper left x-coordinate of the region for drawing the character string is 20, the upper left y-coordinate is 20, the lower right x-coordinate is 100, the lower right y-coordinate is 30, and the character string to be drawn is “987654321”. Reference numeral 522 indicates information related to text. Specifically, it indicates that the font is a gothic typeface, the upper left x-coordinate of the region for drawing the character string is 20, the upper left y-coordinate is 60, the lower right x-coordinate is 90, the lower right y-coordinate is 70, and the character string to be drawn is “Hanako Sato”. Reference numeral 524 indicates the end of the page for the second page.

The content obtained by drawing the first page according to instructions of PDL commands of FIG. 5A above corresponds to FIG. 5B, and the content obtained by drawing on the second page corresponds to FIG. 5C. FIG. 5B illustrates the drawing content of the first page, and FIG. 5C illustrates the drawing content of the second page. Using portions of FIGS. 5B and 5C as examples, text 511 and text 512 in FIG. 5B, and text 521 and text 522 in FIG. 5C respectively are a variable region portion in which character strings of different content are inserted in the same position. Meanwhile, an image 513 in FIG. 5B and an image 523 in FIG. 5C respectively are a fixed region portion in which the same image is inserted in the same position.

### <Ground Truth CSV>

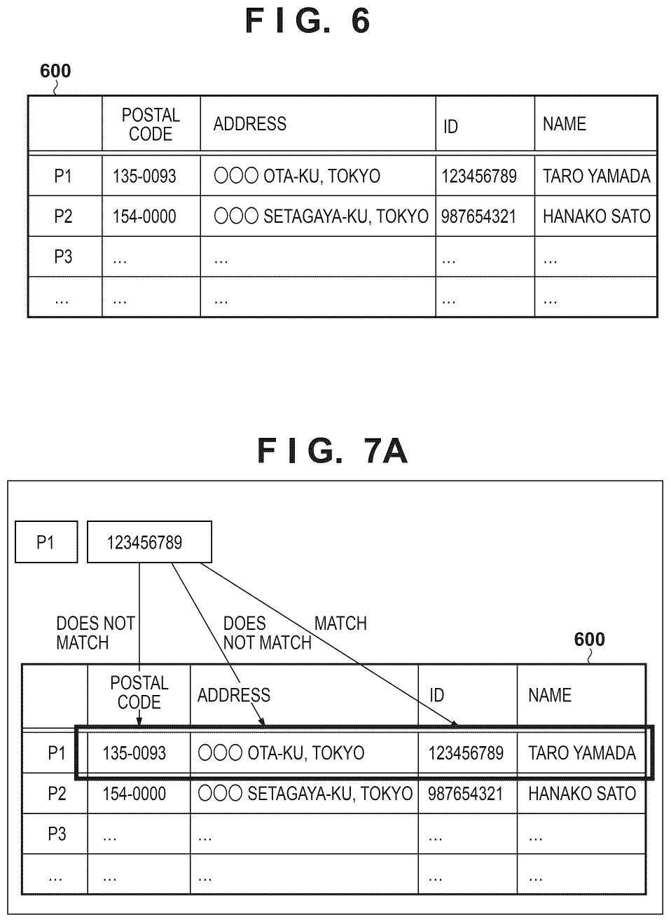

Next, ground truth CSV will be described with reference to FIG. 6. Ground truth CSV 600 describes ground truth character strings that go into variable region portions of variable data. Each column in the first row indicates header information (e.g., postal code, address, etc.) of a character string to be inserted into a variable region portion. The next row (second row) indicates character strings to be inserted into variable region portions of the first page. Each column stores a character string corresponding to header information. For example, it is indicated that a ground truth character string of a postal code of the first page is “135-0093”. That is, the row of the first page contains data of character strings that go into respective variable region portions of variable data included in the first page. Further, the next row (third row) indicates ground truth character strings to be inserted into variable region portions of the second page. In this way, from the second row onward, row N indicates information of an (N−1)-th page.

However, because ground truth CSV does not contain information on where a ground truth character string is positioned on the page, it is necessary to associate position information in the page with ground truth character string information. The association processing will be described later in detail. The format of ground truth CSV is only one example and is not limited to this. The information of ground truth character strings to be inserted into variable region portions of the page need only be managed, and a configuration may be taken so as to use information managed on Excel or a database.

### <Inspection Setting Processing>

Next, a procedure of inspection setting processing performed by the CPU 101 according to the present embodiment will be described with reference to FIG. 4. The processing to be described below is realized, for example, by the CPU 101 reading a program stored in the ROM 103 or the storage apparatus 105 to the RAM 102 and executing the program. The description of FIG. 4 will be given using variable data illustrated in FIGS. 5A to 5C and the ground truth CSV illustrated in FIG. 6.

In step S401, the data analysis unit 202 extracts a page number from a PDL page start command in the variable data and acquires the next command. For example, in the case of the PDL page start command 510, the page number “P1” is acquired, and in the case of the PDL page start command 520, the page number “P2” is acquired. Next, in step S402, the data analysis unit 202 determines whether the acquired command is text data. If the acquired command is text (YES in step S402), the processing proceeds to step S403; if it is not text data (NO in step S402), the next command is acquired, and the processing proceeds to step S407.

In step S403, the data analysis unit 202 acquires text information necessary for inspection setting from the command. The position information of the text and the character string of the text are acquired as the text information. For example, in the case of the PDL text command 511, “20, 20, 100, 30” is extracted as the position information of the text, and “123456789” as the character string of the text.

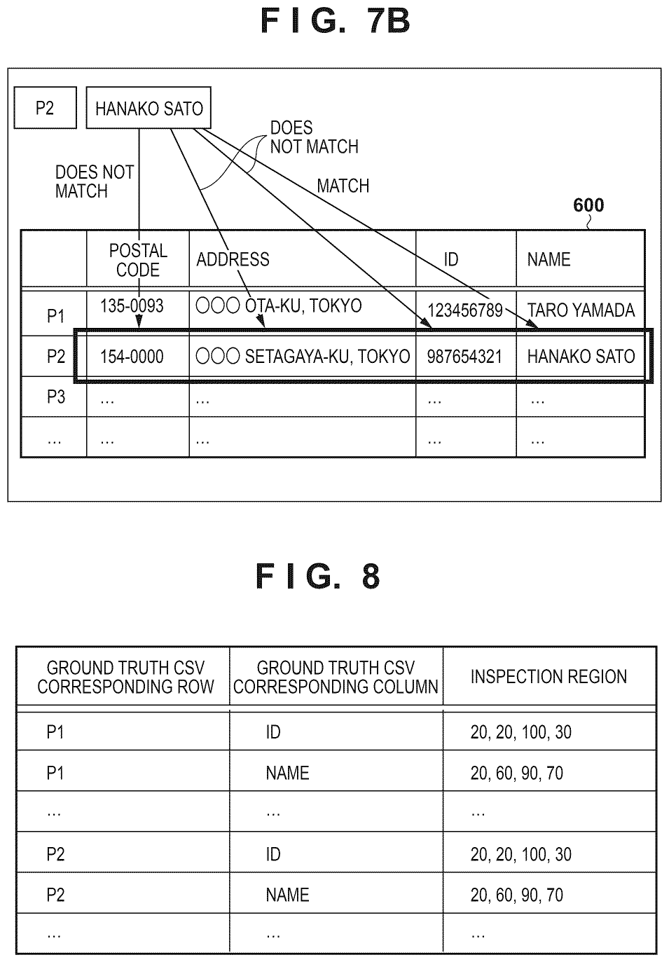

Next, in step S404, the inspection setting generation unit 203 searches the ground truth CSV as to whether there is a matching item, based on the extracted page number and the text information. Here, an example of the search processing will be described with reference to FIGS. 7A and 7B. FIG. 7A illustrates searching the ground truth CSV 600 using the information of the page number “P1” and the character string “123456789”. First, since the page number is “P1”, the search target will be each column in the second row in the ground truth CSV 600. The inspection setting generation unit 203 performs comparison, with the character string “123456789” as the search key, for each column in order until there is a match. Here, the inspection setting generation unit 203 determines that “135-0093” of “postal code” and “∘∘∘ Ota-ku, Tokyo” of “address” are not a match, and determines that “123456789” of “ID” is a match. Similarly, FIG. 7B illustrates searching the ground truth CSV 600 using information which is the page number “P2” and the character string “Hanako Sato”. First, since the page number is “P2”, the search target will be each column in the third row in the ground truth CSV 600. Then, the inspection setting generation unit 203 performs comparison, with the character string “Hanako Sato” as the search key, for each column in order until there is a match. Here, the inspection setting generation unit 203 determines that “154-0000” of “postal code”, “∘∘∘ Setagaya-ku, Tokyo” of “address”, and “987654321” of “ID” are not a match, and determines that “Hanako Sato” of “name” is a match. If there is a matching item (YES in step S405), the processing proceeds to step S406, and if there are no matching items (NO in step S405), the processing proceeds to step S407.

In step S406, the inspection setting generation unit 203, for a matching item, associates a corresponding row (page number) and a corresponding column (header information) of the ground truth CSV with the position information of the text that is an inspection region and adds the associated information to the associated information list, and acquires the next command. The associated information list is generated when information is first added. In step S407, if the acquired command is a page end instruction (YES in step S407), the inspection setting generation unit 203 acquires the next command and proceeds to step S408. If the acquired command is not a page end instruction (NO in step S407), the processing proceeds to step S402.

In step S408, if the acquired command is a job end instruction (YES in step S408), the inspection setting generation unit 203 terminates the processing of the flowchart. Meanwhile, if the acquired command is not a job end instruction (NO in step S408), the processing proceeds to step S401 so as to proceed to the inspection setting processing of the next page. In this way, in the present embodiment, the association processing for all the pages defined in the ground truth CSV is performed, and the list of associated information associated with the ground truth CSV of all the pages is generated.

Here, an example of the associated information list is illustrated in FIG. 8. In FIG. 7A, “123456789” of “ID” in the ground truth CSV 600 is a match, using the page number “P1” and the character string “123456789” extracted from the variable data. Accordingly, “P1” and “ID” which are a corresponding row (page number) and a corresponding column (header information), respectively, of the ground truth CSV, and “20, 20, 100, 30” which is position information of the text that is an inspection region are added in association with each other to the associated information list. That is, the ground truth CSV which is the ground truth data is associated with the position information of an inspection region in the associated information list. Similarly, matching items are added to the list. With this, a finally generated list is an associated information list 800.

### <Inspection Processing>

Next, a specific procedure of the inspection processing of step S303 will be described with reference to FIG. 9. In step S303, inspection is performed based on the associated information list 800. Using the second row of the associated information list 800 as an example, it is indicated that in the inspection processing, a character string in the inspection region “20, 20, 100, 30” of the page “P1” be compared with the “ID” of the page “P1”. Therefore, the OCR unit 204 performs OCR processing on the inspection region “20, 20, 100, 30” in a scanned image 900 of the first page. The inspection unit 205 compares a character string recognized as a result of OCR processing with the ground truth character string “123456789” indicated under “P1” which is the corresponding row (page number) and “ID” which is the corresponding column (header information) of the ground truth CSV 600. The character string inspection of variable region portions is performed by repeating similar processing as many times as the number of entries in the associated information list 800.

As described above, the information processing apparatus according to the present embodiment acquires print data and ground truth data and extracts, for each character string region in the page where a character string is formed, information related to that character string from the print data. The information processing apparatus searches the ground truth data for information matching at least a part of the extracted information related to the character string, and generates a list defining the found ground truth data and a corresponding character string region in association with each other. With this, by using PDL command information in variable data, it is possible to automate inspection setting from designation of an inspection region to association thereof with an item in a ground truth CSV file, which are for performing variable printing character string inspection. Therefore, it becomes possible to reduce the workload of an inspection worker who had to perform settings manually thus far. As described above, according to the present embodiment, it is possible to provide a mechanism for automating association of ground truth data with an inspection target in character string inspection of printed matter.

### Second Embodiment

A second embodiment for implementing the present invention will be described below with reference to the drawings. In the present embodiment, in addition to the configuration of the above embodiment, processing for issuing a warning when there is no match with a column of ground truth CSV only in a particular page will be further described. A configuration of the printing control apparatus of the present embodiment is similar to the configuration illustrated in FIG. 1. Configurations and control different from those of the above first embodiment will be mainly described below.

### <Overall Processing>

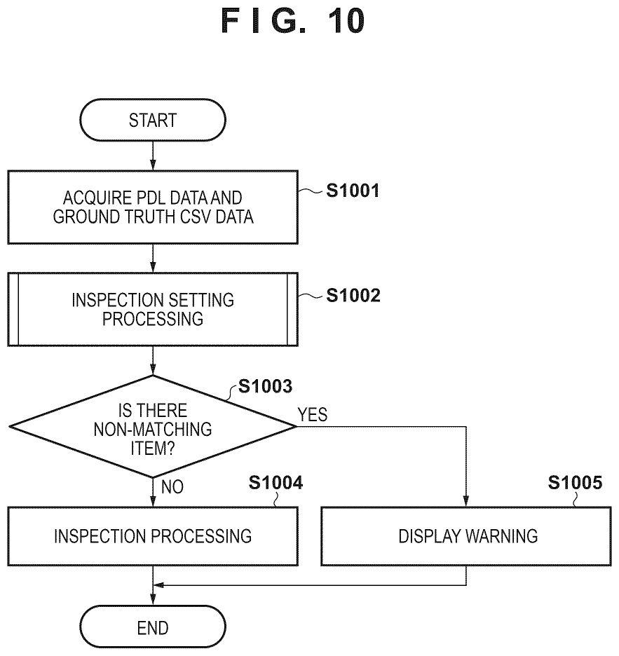

First, the entire processing procedure from inspection setting to inspection performed by the CPU 101 according to the present embodiment will be described with reference to FIG. 10. The processing to be described below is realized, for example, by the CPU 101 reading a program stored in the ROM 103 or the storage apparatus 105 to the RAM 102 and executing the program.

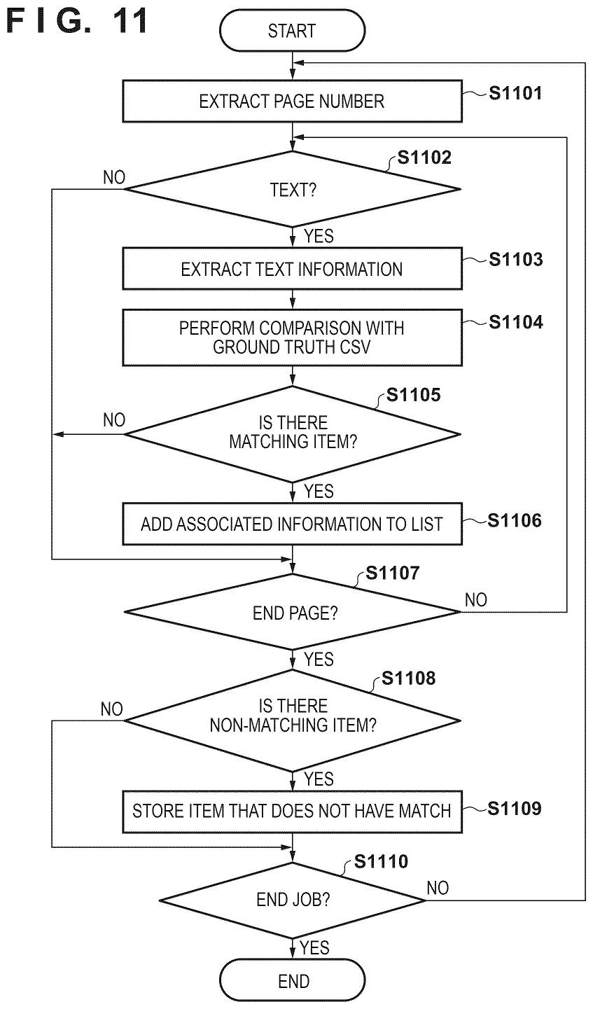

In step S1001, the CPU 101 causes the data acquisition unit 201 to receive PDL data and a ground truth CSV file through the network I/F 104. Then, in step S1002, the CPU 101 causes the data analysis unit 202 and the inspection setting generation unit 203 to analyze the received PDL data and compare it with the ground truth CSV file to generate a list of associated information in which an inspection region is associated with an item in the ground truth CSV file. The processing of step S1002 will be described in detail later with reference to FIG. 11.

Next, in step S1003, the CPU 101 checks whether there was a non-matching item (whether there was non-matching information) in the processing of step S1002. The determination as to whether there is non-matching information is performed by checking whether there is non-matching information stored in step S1109 to be described later. If an item matches in all pages (NO in step S1003), the processing proceeds to step S1004, and if there is a non-matching item (YES in step S1003), the processing proceeds to step S1005. In step S1004, the CPU 101 causes the OCR unit 204 and the inspection unit 205 to execute inspection processing in which OCR is performed on a scanned image of printed matter and the OCR result is compared with a corresponding item in the ground truth CSV file based on the associated information list, and terminates the processing of the flowchart.

Meanwhile, in step S1005, the CPU 101 does not cause the inspection unit 205 to start the inspection processing as it is likely that there is an error in either the variable data or the ground truth CSV, causes the UI 106, which is a display unit, to display a warning, and terminates the processing of the flowchart. The content of the warning is not particularly limited, but display is performed based on the content of the above non-matching information. For example, it is desirable to display information of a non-matching character string.

### <Inspection Setting Processing>

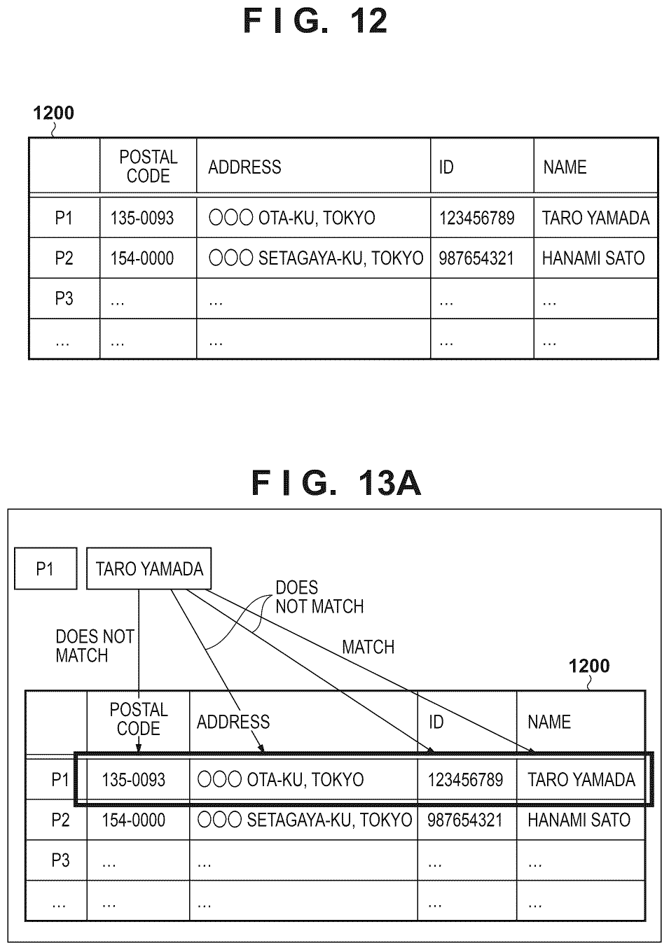

Next, a processing procedure of inspection setting processing performed by the CPU 101 according to the present embodiment will be described with reference to FIG. 11. The processing to be described below is realized, for example, by the CPU 101 reading a program stored in the ROM 103 or the storage apparatus 105 to the RAM 102 and executing the program. In the above step S1001, the data analysis unit 202 analyzes the received PDL data. In FIG. 11, description will be given using variable data illustrated in FIGS. 5A to 5C and the ground truth CSV illustrated in FIG. 12.

In step S1101, the data analysis unit 202 extracts a page number from a PDL page start command in the variable data and acquires the next command. For example, in the case of the PDL page start command 510, the page number “P1” is acquired, and in the case of the PDL page start command 520, the page number “P2” is acquired. Next, in step S1102, the data analysis unit 202 determines whether the acquired command is text data. If the acquired command is text (YES in step S1102), the processing proceeds to step S1103; if it is not text data (NO in step S1102), the next command is acquired, and the processing proceeds to step S1107.

In step S1103, the data analysis unit 202 acquires text information necessary for inspection setting from the command. The position information of the text and the character string of the text are acquired as the text information. Next, in step S1104, the inspection setting generation unit 203 searches the ground truth CSV as to whether there is a matching item, based on the extracted page number and the text information.

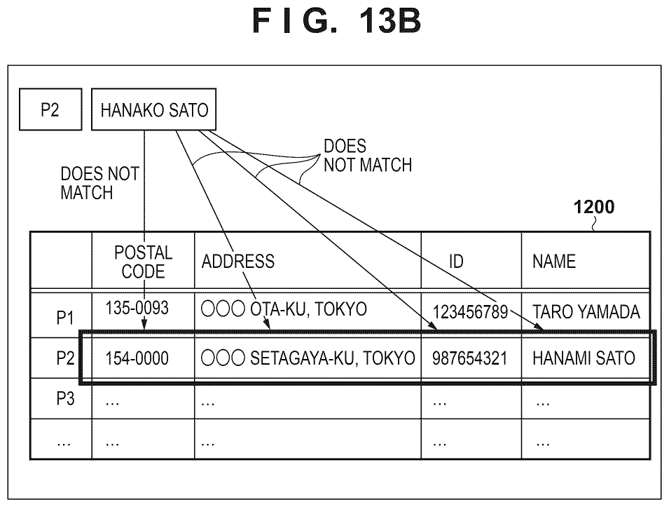

Here, an example of ground truth CSV will be described with reference to FIG. 12 and an example of search processing will be described with reference to FIGS. 13A and 13B. In FIG. 13A, ground truth CSV 1200 is searched using the information of the page number “P1” and the character string “Taro Yamada”. First, since the page number is “P1”, the search target will be each column in the second row in the ground truth CSV 1200. Then, the inspection setting generation unit 203 performs comparison, with the character string “Taro Yamada” as the search key, for each column in order until there is a match. Here, the inspection setting generation unit 203 determines that “135-0093” of “postal code”, “∘∘∘ Ota-ku, Tokyo” of “address”, and “123456789” of “ID” are not a match, and determines that “Taro Yamada” of “name” is a match. Similarly, FIG. 13B illustrates searching the ground truth CSV 1200 using the information of the page number “P2” and the character string “Hanako Sato”. First, since the page number is “P2”, the search target will be each column in the third row in the ground truth CSV 1200. Then, the inspection setting generation unit 203 performs comparison, with the character string “Hanako Sato” as the search key, for each column in order until there is a match. Here, the inspection setting generation unit 203 determines that “154-0000” of “postal code”, “∘∘∘ Setagaya-ku, Tokyo” of “address”, “987654321” of “ID”, and “Hanami Sato” of “name” all are not a match, and determines that there is no matching item. If there is a matching item (YES in step S1105), the processing proceeds to step S1106, and if there are no matching items (NO in step S1105), the processing proceeds to step S1107.

In step S1106, the inspection setting generation unit 203, for a matching item, associates a corresponding row (page number) and a corresponding column (header information) of the ground truth CSV with the position information of the text that is an inspection region and adds the associated information to the list, and acquires the next command. The associated information list is generated when information is first added. In step S1107, if the acquired command is a page end instruction (YES in step S1107), the inspection setting generation unit 203 acquires the next command and proceeds to step S1108. If the acquired command is not a page end instruction (NO in step S1107), the processing proceeds to step S1102.

In step S1108, the inspection setting generation unit 203 checks whether there is a non-matching item. If there is a non-matching item (YES in step S1108), the processing proceeds to step S1109, and if there are no non-matching items (NO in step S1108), the processing proceeds to step S1110. In step S1109, the inspection setting generation unit 203 stores the non-matching items as non-matching information, and advances the processing to step S1110. In the example of FIG. 13, “Hanami Sato” of “name” of the ground truth CSV is stored as an item that ultimately did not match. In step S1110, if the acquired command is a job end instruction (YES in step S1110), the inspection setting generation unit 203 terminates the processing of the flowchart. Meanwhile, if the acquired command is not a job end instruction (NO in step S1110), the processing returns to step S1101.

As described above, when there is no information of a character string that matches ground truth data as a result of a search, the information processing apparatus according to the present embodiment stores corresponding extracted information related to a character string as non-matching information, and displays a warning on a display unit based on the non-matching information. That is, according to the present embodiment, a warning can be issued when there is nothing that matches a column of ground truth CSV for a particular page. This makes it possible to inform an inspection worker that there is a high possibility that there is an error in either variable data or ground truth CSV prior to starting the inspection, and prevent an inspection error in advance.

### Third Embodiment

A third embodiment for implementing the present invention will be described below with reference to the drawings. In the present embodiment, processing for increasing the speed by efficiently performing the association processing for the second page onward will be described as an example. A configuration of the printing control apparatus of the present embodiment is similar to the configuration of the above first embodiment illustrated in FIG. 1. The points different from those of the above first embodiment will be mainly described below.

### <Inspection Setting Processing>

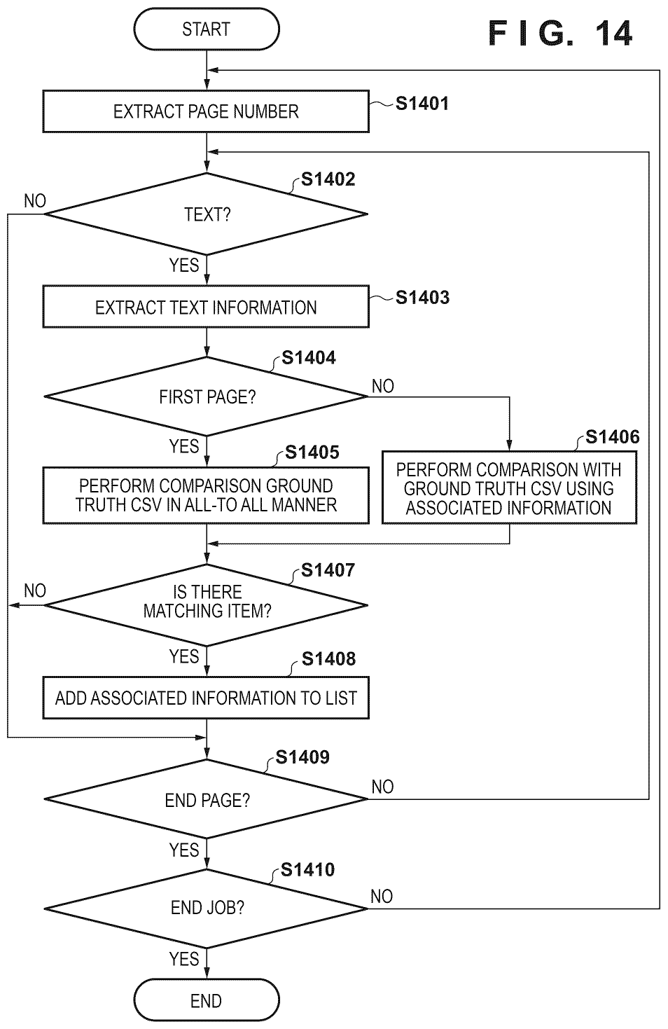

Next, a procedure of inspection setting processing performed by the CPU 101 according to the present embodiment will be described with reference to FIG. 14. The processing to be described below is realized, for example, by the CPU 101 reading a program stored in the ROM 103 or the storage apparatus 105 to the RAM 102 and executing the program. In the above step S301, the data analysis unit 202 analyzes the received PDL data. In FIG. 14, description will be given using variable data of FIGS. 5A to 5C and the ground truth CSV of FIG. 6. The description for the processing similar to that in FIG. 4 will be omitted. That is, description for steps S1401 to S1403 and S1407 to S1410 of FIG. 14 will be omitted as it is similar to that for steps S401 to S403 and S405 to S408, respectively, of FIG. 4.

In step S1404, the inspection setting generation unit 203 checks whether it is the first page. If it is the first page (YES in step S1404), the processing proceeds to step S1405, and if it is the second page onward (NO in step S1404), the processing proceeds to step S1406. In step S1405, the inspection setting generation unit 203 searches the ground truth CSV as to whether there is a matching item, based on the extracted page number and the text information, and proceeds to step S1407.

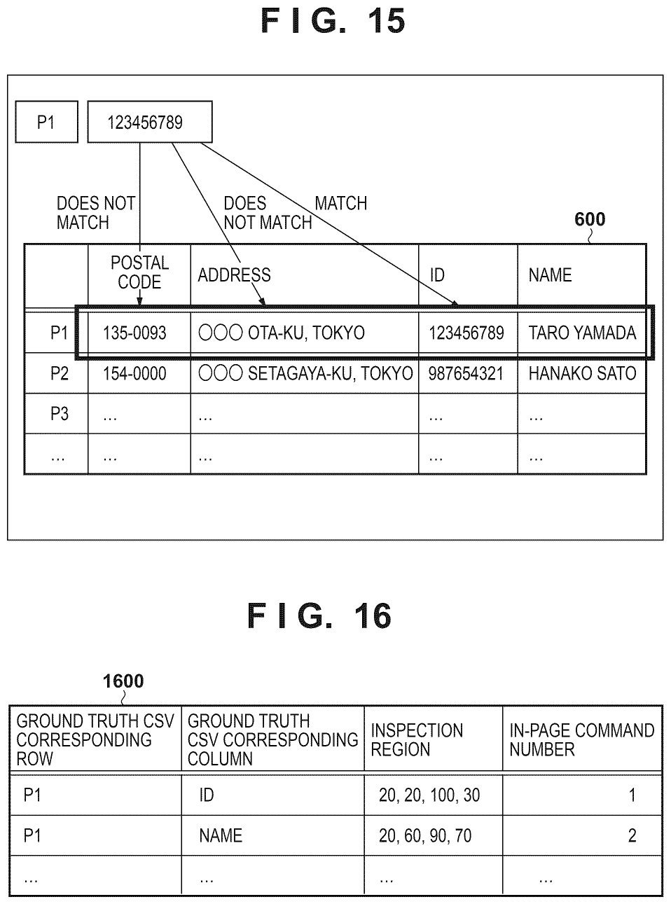

Here, an example of search processing for the first page will be described with reference to FIG. 15. FIG. 15 illustrates searching the ground truth CSV 600 using information which is the page number “P1” and the character string “123456789”. First, since the page number is “P1”, the search target will be each column in the second row in the ground truth CSV 600. Then, the inspection setting generation unit 203 performs comparison (in an all-to-all manner), with the character string “123456789” as the search key, for each column in order until there is a match. Here, the inspection setting generation unit 203 determines that “135-0093” of “postal code” and “∘∘∘ Ota-ku, Tokyo” of “address” are not a match, and determines that “123456789” of “ID” is a match.

Meanwhile, in step S1406, the inspection setting generation unit 203 searches the ground truth CSV as to whether there is a matching item, based on the extracted page number and the text information, using associated information of the first page. Then, the processing proceeds to step S1407.

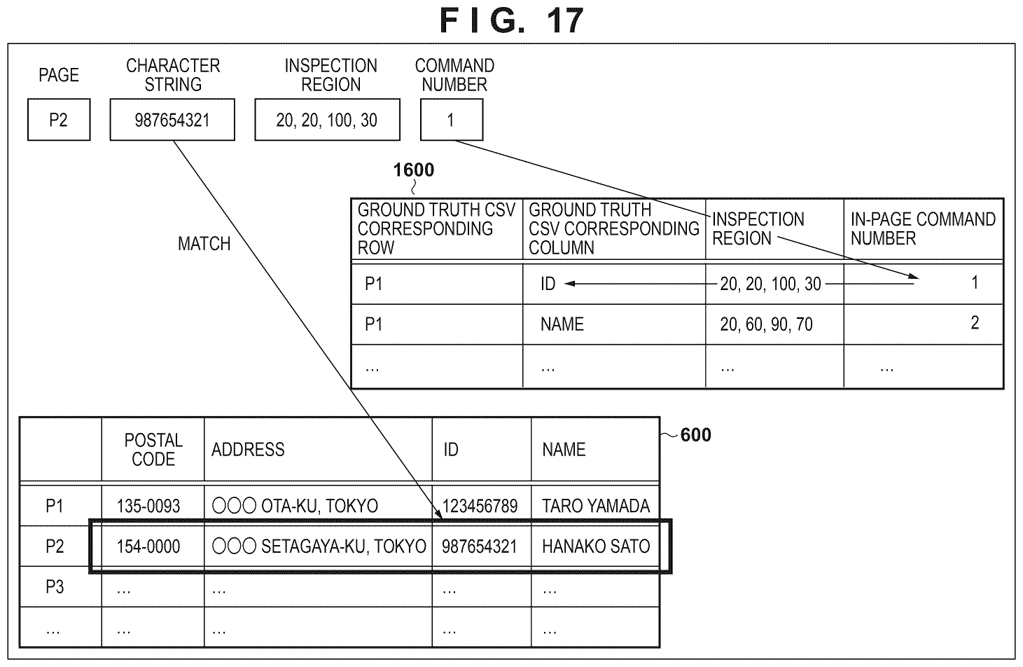

Here, an example of search processing for the second page onward will be described with reference to FIGS. 16 and 17. From the second page onward, there is associated information 1600 generated for the first page as illustrated in FIG. 16. The associated information 1600 stores information that serves as a clue for when searching the ground truth CSV 600, such as information of an inspection region and an in-page command number. Specifically, particular ground truth data is specified by a ground truth CSV corresponding row and a ground truth CSV corresponding column. In addition, the position of an inspection target character string region in the page is specified by information indicated in the inspection region. The in-page command number indicates the number of a PDL command in the page.

FIG. 17 illustrates search processing in which the associated information 1600 is used. In the example of FIG. 17, there is information of the page number “P2”, the character string “987654321”, the inspection region “20, 20, 100, 30”, and the in-page command number “1”, and the information is utilized to search the ground truth CSV 600. First, since the page number is “P2”, the search target will be each column in the third row in the ground truth CSV 600. Next, the information of the in-page command number “1” of the first page is used. In the first page, since the character string of the in-page command number “1” matched with that of “ID”, instead of comparing it with each column in order, it is preferentially compared with the column “ID” first. Thus, it matches with “987654321” of “ID”, and the search processing can be performed at high speed.

The comparison method of the present embodiment is only one example, and a configuration may be taken so as to utilize not the in-page command number but the information of the inspection region and perform comparison with a column of an overlapping region. Further, a configuration may be taken so as to combine a plurality of pieces of information such as the in-page command number and the inspection region and perform a search. In addition, a configuration may be taken so as to suspend processing when no match is found using clue information and issue a warning, or a method such as switching to an all-to-all search method as in the first page may be taken.

As described above, for the second page onward, the information processing apparatus according to the present embodiment preferentially performs a search with a particular character string of ground truth data, based on the list generated for the first page. Thus, according to the present embodiment, the association processing of the second page onward is efficiently performed using the information of the first page. This makes it possible to perform the association processing at a high speed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-207173, filed Dec. 7, 2023 which is hereby incorporated by reference herein in its entirety.

What is claimed is:

1. An information processing apparatus comprising:
one or more memory devices that store a set of instructions; and
one or more processors that execute the set of instructions to:
acquire print data and ground truth data;
extract, from the print data, for each character string region in a page where a character string is formed, information related to that character string;
search the ground truth data for information that matches at least a portion of the extracted information related to the character string; and
generate a list defining the searched ground truth data and a corresponding character string region in association with each other.

2. The information processing apparatus according to claim 1, wherein
the information related to the character string includes, for each character string region in the page, a position of that character string region and content of that character string, and
the list includes information of a position of the corresponding character string region.

3. The information processing apparatus according to claim 2, wherein the one or more processors further execute the set of instructions to:
acquire a scanned image of printed matter;
recognize a character string in the scanned image; and
execute inspection by comparing the recognized character string and the ground truth data of a character string region defined in the list so as to correspond to a position, in a page, of the recognized character string.

4. The information processing apparatus according to claim 3, wherein
in the ground truth data, a character string included in a respective page is defined, and
the one or more processors further execute the set of instructions to:
perform a search, with the extracted character string as a search key, by determining whether a character string defined in a corresponding page of the ground truth data includes a character string that matches with that search key.

5. The information processing apparatus according to claim 4, wherein
the one or more processors further execute the set of instructions to:
search for the search key in the character string defined in a corresponding page of the ground truth data in an all-to-all manner.

6. The information processing apparatus according to claim 4, wherein
the one or more processors further execute the set of instructions to:
in a first page, search for the search key in the character string defined in a corresponding page of the ground truth data in an all-to-all manner, and
in a second page onward, preferentially perform a search in a particular character string of the ground truth data, based on the list generated for the first page.

7. The information processing apparatus according to claim 1, wherein the one or more processors further execute the set of instructions to:
as a result of the search, in a case where there is no information of a matching character string in the ground truth data, store corresponding extracted information related to the character string as non-matching information; and
display on a display unit a warning based on the non-matching information.

8. The information processing apparatus according to claim 7, wherein
the list includes associated information of all character string regions of each page and ground truth data.

9. The information processing apparatus according to claim 7, wherein
the character string region is a variable region for which content of a character string changes for each page.

10. The information processing apparatus according to claim 7, further comprising:
a printer configured to execute printing using the print data.

11. The information processing apparatus according to claim 7, further comprising:
a scanner configured to read printed matter and output a scanned image.

12. The information processing apparatus according to claim 7, further comprising:
a printer configured to execute printing using the print data; and
a scanner configured to read printed matter formed by the printer and output a scanned image.

13. A method of controlling an information processing apparatus, the method comprising:
acquiring print data and ground truth data;
extracting, from the print data, for each character string region in a page where a character string is formed, information related to that character string;
searching the ground truth data for information that matches at least a portion of the extracted information related to the character string; and
generating a list defining the searched ground truth data and a corresponding character string region in association with each other.
